(19) United States
(12) Patent Application Publication
(10) Pub. No.: US 2026/0201979 A1
(43) Pub. Date: Jul. 16, 2026

(54) PRESSURE-BALANCED VALVE

(71) Applicant: AEROJET ROCKETDYNE, INC., Melbourne, FL (US)

(72) Inventor: Arturo Tolentino, Redmond, WA (US)

(21) Appl. No.: 19/136,952

(22) PCT Filed: Jan. 11, 2023
(86) PCT No.: PCT/US2023/010575

§ 371 Date: Jun. 9, 2025

(51) Int. Cl. F16K 39/02; F16K 1/44

(52) U.S. Cl. CPC F16K 39/022; F16K 1/44

(57) ABSTRACT

A valve includes a first seal seat, a second seal seat, and a flow path for a fluid across the first seal seat. A seal is sealed against the first seal seat and the second seal seat. An actuator is adjacent the first seal seat and is operable to deflect the seal and thereby permit flow of the fluid through the flow path. the seal defines a through-passage fluidly connecting the first seal seat to a pressure-balance cavity behind the seal at the second seal seat.

### BACKGROUND

Liquid rocket engines and other types of engines are powered by one or more combustible fluids that are provided to a combustion chamber. For example, the fluid may be moved from a storage tank through a series of supply lines to the combustion chamber. The flow of the fluid is regulated in accordance with the desired operation of the engine. In that regard, one or more flow-control valves, such as a poppet valve or a pintle valve, are known for managing fluid flow.

### SUMMARY

A valve according to an example of the present disclosure includes a first seal seat, a second seal seat, and a flow path for a fluid across the first seal seat. A seal is sealed against the first seal seat and the second seal seat. An actuator is adjacent to the first seal seat and is operable to deflect the seal and thereby permit flow of the fluid through the flow path. The seal defines a through-passage that fluidly connects the first seal seat to a pressure-balance cavity behind the seal at the second seal seat.

In a further embodiment of any of the foregoing embodiments, the seal has a first seal side sealed against the first seal seat, a second seal side opposite the first seal side and sealed against the second seal seat, and the through-passage fluidly connects the first seal side and the second seal side.

In a further embodiment of any of the foregoing embodiments, the second seal side remains sealed against the second seal seat upon operation of the actuator to deflect the seal.

In a further embodiment of any of the foregoing embodiments, the seal is elastomeric.

In a further embodiment of any of the foregoing embodiments, the seal defines a central axis, and the through-passage is coaxial with the central axis.

In a further embodiment of any of the foregoing embodiments, the first seal seat includes a port that is coaxial with the central axis and through which a pintle portion of the actuator extends.

In a further embodiment of any of the foregoing embodiments, the pintle portion has a through hole that is coaxial with the central axis and fluidly connected with the through-passage of the seal

In a further embodiment of any of the foregoing embodiments, the flow path extends between the pintle portion and the first seal seat.

In a further embodiment of any of the foregoing embodiments, the seal is elastomeric, and the seal has a first seal side sealed against the first seal seat and a second seal side opposite the first seal side and sealed against the second seal seat. The through-passage fluidly connects the first seal side and the second seal side. The seal defines a central axis, and the through-passage is coaxial with the central axis. The first seal seat includes a port that is coaxial with the central axis and through which a pintle portion of the actuator extends. The pintle portion has a through hole that is coaxial with the central axis and fluidly connected with the through-passage of the seal, and the flow path extends between the pintle portion and the first seal seat.

A valve according to an example of the present disclosure includes a first seal seat, a second seal seat, and a flow path for a fluid across the first seal seat. A seal has a closed state in which the seal is sealed against the first seal seat to block flow of the fluid through the flow path and an open state in which the seal is deflected with respect to the first seal seat to permit flow of the fluid through the flow path. The second seal seat is sealed against the second seal seat in both the open state and the closed state. An actuator adjacent the first seal seat and is operable to deflect the seal to move from the closed state to the open state. The seal defines a through-passage fluidly connecting the first seal seat to a pressure-balance cavity behind the seal at the second seal seat. The through-passage permits the fluid to flow to the pressure-balance cavity and create a pressure-balance across the seal in the closed state.

In a further embodiment of any of the foregoing embodiments, the seal has a first seal side sealed against the first seal seat in the closed state, a second seal side opposite the first seal side and sealed against the second seal seat in the open state and the closed state, and the through-passage fluidly connects the first seal side and the second seal side.

In a further embodiment of any of the foregoing embodiments, the seal is elastomeric.

In a further embodiment of any of the foregoing embodiments, the seal defines a central axis, and the through-passage is coaxial with the central axis.

In a further embodiment of any of the foregoing embodiments, the first seal seat includes a port that is coaxial with the central axis and through which a pintle portion of the actuator extends.

In a further embodiment of any of the foregoing embodiments, the pintle portion has a through hole that is coaxial with the central axis and fluidly connected with the through-passage of the seal

In a further embodiment of any of the foregoing embodiments, the flow path extends between the pintle portion and the first seal seat.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description and drawing, which is not to scale. The drawing can be briefly described as follows.

FIG. 1 illustrates an example of a pressure-balanced valve.

In this disclosure, like reference numerals designate like elements where appropriate and reference numerals with the addition of one-hundred or multiples thereof designate modified elements that are understood to incorporate the same features and benefits of the corresponding elements.

### DETAILED DESCRIPTION

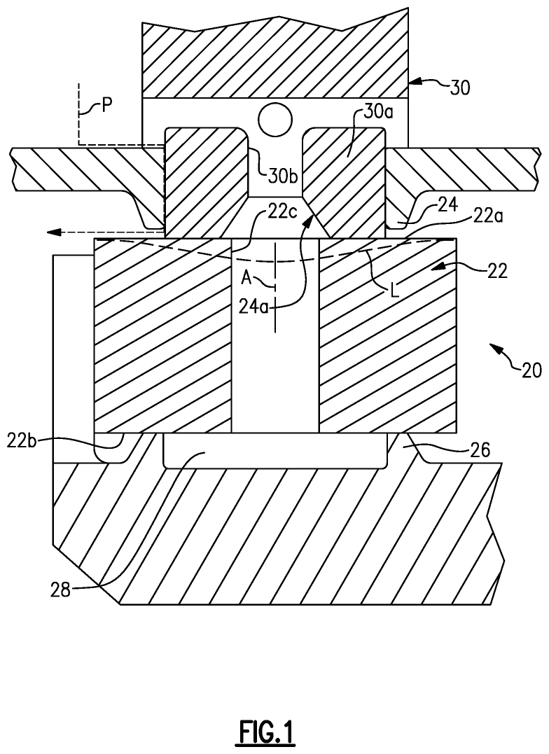

FIG. 1 schematically illustrates a pressure-balanced valve 20. The valve 20 may be used in a rocket engine for controlling flow of a gaseous or liquid fluids but is not limited thereto. The valve 20 generally includes a seal 22 that is disposed between first and second seal seats 24/26. The valve 20 defines a flow path (P) across the first seal seat 24 for a fluid to flow there through. Although not shown, the seal 22 and seal seats 24/26 may be contained in a valve housing, which may also include an inlet port for flow into the valve 20 and an outlet port for flow from the valve 20.

In this example, the seal 22 is cylindrical and defines a central axis A, although the seal 22 is not limited to this shape could alternatively have a different geometry, such as a polyhedron. Each of the seal seats 24/26 is an upstanding ridge that is of complementary configuration to that of the seal 22. For example, for the cylindrical seal 22, the seal seats 24/26 are circular. For a polyhedron seal 22, the seal seats 24/26 may be polygonal with the same number of sides as the cross-section of the polyhedron or the seal seats 24/26 may circular but encompassed within the cross-section of the polyhedron. The tip ends of the ridges of the seal seats 24/26 serve as sealing surfaces. At one axial end the seal 22 has a first seal side 22a and at its opposed axial end the seal 22 has a second seal side 22b. In the closed state as shown, the first seal side 22a is sealed against the first seal seat 24 to block flow through the flow path P. The second seal side 22b is sealed against the second seal seat 26 and remains in sealing contact in both the closed and open states of the valve 20. The seal 22 is thus sandwiched between the seal seats 24/26.

The seal 22 further defines a through-passage 22c from the first seal side 22a to the second seal side 22b and that is generally coaxial with the axis A. The through-passage 22c fluidly connects the first seal seat 24 to a pressure-balance cavity 28 behind the seal 22 at the second seal seat 26. The pressure-balance cavity 28 is bound on its lateral sides by the ridge of the second seal seat 26.

There is an actuator 30 adjacent the first seal seat 24. The actuator 30 includes a pintle portion 30a and is electromagnetically operable via an electric current to move the pintle portion 30a with respect the seal 22. For example, the actuator 30 is operable to move the pintle portion 30a toward the seal 22, thereby causing the seal 22 to deflect from its static home state to a deflected state represented at dashed line L. Upon retraction of the pintle portion 30a away from the seal 22, the seal 22 rebounds to its home state. In this regard, the seal 22 is made of an elastomer and is capable of elastically recovering from the deflected state back to the home state. For example, the elastomer may be, but is not limited to, a fluoroelastomer (FKM) or ethylene propylene diene monomer (EPDM).

The actuator 30 is selectively operated via electric current to switch the valve 20 between the closed and open states. In the closed state, the pintle portion 30a is retracted and does not exert any actuated force on the seal 22. In this state, the seal 22 contacts and seals against the first seal seat 24 to block (e.g., prevent) flow through the flow path P. When the actuator 30 is activated to extend the pintle portion 30a against the seal 22, the seal 22 deflects and thereby moves from the closed state to the open state. In the open state, the deflection of the seal 22 moves the seal 22 off of the first seal seat 24, thereby permitting flow through the flow path P between the first seal seat 24 and the outside of the pintle portion 30a as shown. The stroke length of the pintle portion 30a may be controlled to deflect the seal 22 by different amounts to provide greater or lesser flow through the flow path P.

The first seal seat 24 includes a port 24a that is coaxial with the central axis A. The port 24a is bound on its lateral sides by the ridge of the first seal seat 24. The pintle portion 30 a extends through the port 24 a. The pintle portion 30 a has a through-hole 30b that is also coaxial with the central axis A. The through-hole 30b is open to the flow path P upstream of the first seal seat 24 and fluidly connects to the pressure-balance cavity 28 via the through-passage 22c of the seal 22. Thus, during operation of the valve 20, fluid pressure is present at both the first seal side 22a and the second seal side 22b. In this regard, the areas of the first seal side 22a and the second seal side 22b that are exposed to the fluid with the valve 20 in the closed state are substantially equivalent such that there is a pressure-balance across the seal 22. That is, there is a net zero fluid pressure on the seal 22 because the pressure the fluid exerts on the end of the seal 22 at the first seal seat 24 is equal to the pressure the fluid exerts on the end of the seal 22 at the second seal seat 26.

The pressure-balance serves to make the valve 20 substantially insensitive to the pressure of the fluid. For example, absent the through-passage 22c in the seal 22 and the pressure-balance cavity 28, the fluid would exert pressure only on the first seal side 22a near the first seal seat 24. This would result in a net fluid pressure on the seal 22 which, if high enough, could cause unintended deflection of the seal 22 and thus leakage of the fluid. Accordingly, the pressure-balance in the valve 20 and its substantial insensitivity to the pressure of the fluid avoids such issues.

Although a combination of features is shown in the illustrated examples, not all of them need to be combined to realize the benefits of various embodiments of this disclosure. In other words, a system designed according to an embodiment of this disclosure will not necessarily include all of the features shown in the Figure or all of the portions schematically shown in the Figure. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A valve comprising:
a first seal seat, a second seal seat, and a flow path for a fluid across the first seal seat;
a seal sealed against the first seal seat and the second seal seat;
an actuator adjacent the first seal seat and operable to deflect the seal and thereby permit flow of the fluid through the flow path; and
the seal defining a through-passage fluidly connecting the first seal seat to a pressure-balance cavity behind the seal at the second seal seat.

2. The valve as recited in claim 1, wherein the seal has a first seal side sealed against the first seal seat, a second seal side opposite the first seal side and sealed against the second seal seat, and the through-passage fluidly connects the first seal side and the second seal side.

3. The valve as recited in claim 2, wherein the second seal side remains sealed against the second seal seat upon operation of the actuator to deflect the seal.

4. The valve as recited in claim 1, wherein the seal is elastomeric.

5. The valve as recited in claim 1, wherein the seal defines a central axis, and the through-passage is coaxial with the central axis.

6. The valve as recited in claim 5, wherein the first seal seat includes a port that is coaxial with the central axis and through which a pintle portion of the actuator extends.

7. The valve as recited in claim 6, wherein the pintle portion has a through hole that is coaxial with the central axis and fluidly connected with the through-passage of the seal

8. The valve as recited in claim 7, wherein the flow path extends between the pintle portion and the first seal seat.

9. The valve as recited in claim 1, wherein the seal is elastomeric, the seal has a first seal side sealed against the first seal seat, a second seal side opposite the first seal side and sealed against the second seal seat, the through-passage fluidly connects the first seal side and the second seal side, the seal defines a central axis, the through-passage is coaxial with the central axis, the first seal seat includes a port that is coaxial with the central axis and through which a pintle portion of the actuator extends, the pintle portion has a through hole that is coaxial with the central axis and fluidly connected with the through-passage of the seal, and the flow path extends between the pintle portion and the first seal seat.

10. A valve comprising:
a first seal seat, a second seal seat, and a flow path for a fluid across the first seal seat;
a seal having a closed state in which the seal is sealed against the first seal seat to block flow of the fluid through the flow path and an open state in which the seal is deflected with respect to the first seal seat to permit flow of the fluid through the flow path, the second seal seat being sealed against the second seal seat in both the open state and the closed state;
an actuator adjacent the first seal seat and operable to deflect the seal to move from the closed state to the open state; and
the seal defining a through-passage fluidly connecting the first seal seat to a pressure-balance cavity behind the seal at the second seal seat, the through-passage permitting the fluid to flow to the pressure-balance cavity and create a pressure-balance across the seal in the closed state.

11. The valve as recited in claim 10, wherein the seal has a first seal side sealed against the first seal seat in the closed state, a second seal side opposite the first seal side and sealed against the second seal seat in the open state and the closed state, and the through-passage fluidly connects the first seal side and the second seal side.

12. The valve as recited in claim 10, wherein the seal is elastomeric.

13. The valve as recited in claim 10, wherein the seal defines a central axis, and the through-passage is coaxial with the central axis.

14. The valve as recited in claim 13, wherein the first seal seat includes a port that is coaxial with the central axis and through which a pintle portion of the actuator extends.

15. The valve as recited in claim 14, wherein the pintle portion has a through hole that is coaxial with the central axis and fluidly connected with the through-passage of the seal

16. The valve as recited in claim 15, wherein the flow path extends between the pintle portion and the first seal seat.
